(19) United States
(12) Patent Application Publication
(10) Pub. No.: US 2011/0149617 A1
(43) Pub. Date: Jun. 23, 2011

(54) AC/AC CONVERSION POWER SUPPLY DEVICE

(75) Inventor: Guo-Hua Wang, Nara (JP)

(73) Assignee: NITTA CORPORATION, Naniwa-ku ,Osaka-shi (JP)

(21) Appl. No.: 12/867,717

(22) PCT Filed: Jan. 7, 2009
(86) PCT No.: PCT/JP2009/000027

§ 371 Date: Aug. 13, 2010

(30) Foreign Application Priority Data
Feb. 18, 2008 (JP) 2008-036188

(51) Int. Cl. H02M 5/42

(52) U.S. Cl. 363/34

(57) ABSTRACT

Provided is an AC/AC conversion power supply device including: n(n≧2) rectification circuits (D1 to Dn) connected in series with respect to an AC input; n high-frequency switching circuits (SC1 to SCn) respectively connected to outputs of the rectification circuits (D1 to Dn); and n transformers (TR1 to TRn) each having a primary winding connected to the outputs of high-frequency switching circuits (SC1 to SCn). The transformers (TR1 to TRn) have secondary windings connected in parallel to one another through the rectification circuits (D1 to Dn) and an output switching circuit (SW) for converting the outputs into AC current. The high-frequency switching circuits (SC1 to SCn) include delay circuits (C14, R14; C24, R24) which can delay a waveform of the high-frequency switching signal.

### TECHNICAL FIELD

The present invention relates to an alternating current/alternating current (AC/AC) conversion power supply device (also referred to as an “electronic transformer”) for obtaining an AC output obtained by voltage-converting an AC input.

### BACKGROUND ART

Prior art Document 1 (U.S. Pat. No. 4,062,057) discusses a power supply device in which a commercial AC power supply is rectified to obtain a direct current (DC) voltage, a plurality of inverters are connected in series with the DC voltage, a high-frequency voltage obtained from each of the inverters is insulated and raised or lowered by a transformer, and respective secondary output voltages Vout of the transformers are connected in parallel with one another while being rectified/smoothed by a rectification circuit, to obtain one DC voltage (FIG. 1 of the Document 1).

In the above power supply device, the commercial AC power supply is rectified to obtain the DC voltage, the DC voltage is then equally divided, and voltages obtained by the equal division are respectively input to the inverters.

In the above power supply device, the plurality of inverters are connected in series with the DC voltage. Therefore, an equalization circuit including a resistor, a choke, and a capacitor is required, so that the number of circuit components increases.

When the power supply device is applied to an AC/AC conversion power supply device that handles power, a loss cannot be neglected that is generated for the AC/AC conversion power supply device to pass through the equalization circuit.

The present invention is directed to providing an AC/AC conversion power supply device having a simple circuit configuration and having a low power loss.

### SUMMARY OF THE INVENTION

An AC/AC conversion power supply device according to the present invention includes n (n≧2) rectification circuits connected in series with an AC input, n high-frequency switching circuits respectively connected to outputs of the rectification circuits, n transformers respectively having primary windings connected to outputs of the high-frequency switching circuits, and output-side rectification circuits respectively connected to secondary windings of the n transformers, in which outputs after rectification of the output-side rectification circuits are connected in parallel with one another, and further includes an output switching circuit for converting the output after the rectification of the output-side rectification circuits into an AC voltage.

This configuration eliminates use of an equalization circuit, and enables implementation of an AC/AC conversion power supply device having a simple circuit configuration and having a low power loss.

The high-frequency switching circuit may include a delay circuit capable of delaying a waveform of a high-frequency switching signal. The use of the delay circuit enables the phase of the high-frequency switching signal used in each of the high-frequency switching circuits to be dispersed among the high-frequency switching circuits. Therefore, the high-frequency switching signal included in an output voltage of the AC/AC conversion power supply device can be easily dispersed and absorbed on a time basis.

Particularly when a high-frequency smoothing device is connected to the output after the rectification of the output-side rectification circuit, the capacity (rectifying ability) of the high-frequency smoothing device can be made low while a rush current entering the high-frequency smoothing device can be reduced.

If a delay time per one of the high-frequency switching circuits is T/n, where T is one period of the high-frequency switching signal, the phase of the high-frequency switching signal can be equally dispersed over one period of the high-frequency switching signal.

If the AC/AC conversion power supply device may further include a transmission circuit that transmits the waveform of the high-frequency switching signal, which has been delayed by the delay circuit, from one of the high-frequency switching circuits to the other high-frequency switching circuits, a delay time of each of the high-frequency switching circuits can be delayed in multiples while the high-frequency switching signals are reliably synchronized.

Each of the high-frequency switching circuits may have a second transformer installed therein to cause a transistor device to perform a switching operation, the second transformer may include a primary winding for receiving feeding of the high-frequency switching signal, a secondary winding connected to the transistor device, and a ternary winding for delaying the waveform of the high-frequency switching signal, and an output of the ternary winding may be connected to a primary winding of a second transformer in the other high-frequency switching circuit. The delay signal generated in the ternary winding is fed to the second transformers in the other high-frequency switching circuits so that the waveform of the high-frequency switching signal can be delayed among the high-frequency switching circuits.

The AC/AC conversion power supply device may further include a protection circuit for notifying a fact that an output voltage of the AC/AC conversion power supply device exceeds a threshold. As the high-frequency switching circuits are connected in series with the AC input, when any one of the high-frequency switching circuits is short-circuited, the output voltage of the AC/AC conversion power supply device rises, to adversely affect a load device. Therefore, the protection circuit for notifying that the output voltage of the AC/AC conversion power supply device exceeds the threshold may be provided.

The AC/AC conversion power supply device may include not only the protection circuit for making notification but also a monitoring control circuit. The monitoring control circuit can automatically adjust an output voltage of the AC/AC conversion power supply device by detecting the output voltage of the AC/AC conversion power supply device, comparing the detected voltage with a reference value, and setting the number of high-frequency switching circuits the input side of which is short-circuited according to a difference between the detected voltage and the reference value.

As described above, according to the present invention, a variation amount of the high-frequency switching signal included in the output waveform of the high-frequency switching circuit can be reduced. As a result, noise included in the AC voltage obtained by the conversion in the output switching circuit is also reduced. The rush current flowing through the high-frequency smoothing device is reduced. This enables an amount of heat generation to be reduced, enabling AC/AC conversion efficiency to be increased.

The above-mentioned or other advantages, characteristics, and effects of the present invention will become more apparent from the following description of preferred embodiments of the present invention with reference to the attached drawings.

### BRIEF DESCRIPTION OF THE DRAWINGS

FIG. 1 is a circuit diagram of an AC/AC conversion power supply device according to an embodiment of the present invention.

FIG. 2 is a graph illustrating a voltage waveform of each unit in an AC/AC conversion power supply device.

FIG. 3 is a voltage waveform diagram of each unit in a high-frequency switching circuit.

FIG. 4 is an enlarged view illustrating, when the number n of high-frequency switching circuits is four, output waveforms of the first to fourth high-frequency switching circuits.

FIG. 5 illustrates waveforms obtained by respectively rectifying and pulsating four waveforms.

FIG. 6 illustrates a waveform obtained by adding the signal waveforms illustrated in FIG. 5.

FIG. 7 is a circuit diagram of a protection circuit PR included in a high-frequency switching circuit.

FIG. 8 is a circuit diagram of an AC/AC conversion power supply device having an output voltage adjustment function.

FIG. 9 is a circuit diagram illustrating an example of another circuit, of an AC/AC conversion power supply device, for delaying the phase of a high-frequency switching signal.

FIG. 10 illustrates an example of connection in which an AC/AC conversion power supply device is Δ (delta)-connected.

FIG. 11 illustrates an example of connection in which an AC/AC conversion power supply device is Y-connected.

### DESCRIPTION OF SYMBOLS

D1˜Dn rectification circuit
SC1˜SCn high-frequency switching circuit
TR1˜TRn transformer
TS˜TSn transformer (pulse transformer)
SW output switching circuit
C14, R14; C24, R24 delay circuit
CP1, CP2 photo coupler (transmission circuit)
CL output-side capacitor (high-frequency smoothing device)
PR protection circuit
SCR1˜SCRm short circuit
M monitoring control circuit

### DETAILED DESCRIPTION OF EMBODIMENTS

An embodiment of the present invention will be described in detail with reference to the attached drawings.

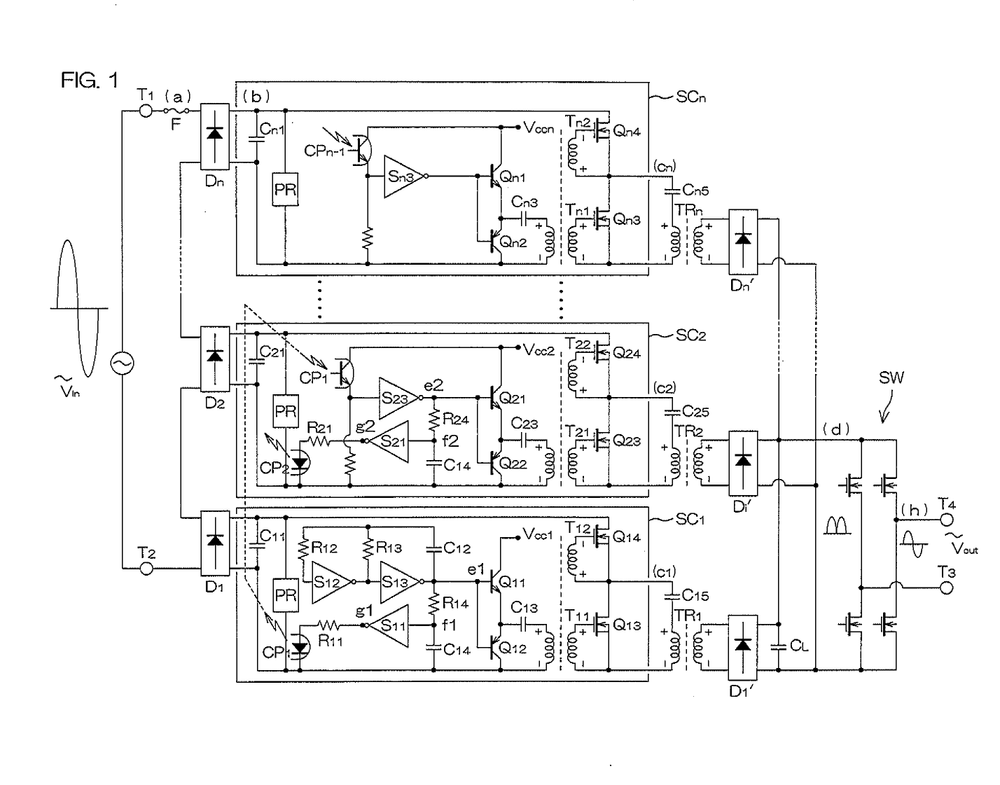

FIG. 1 is a circuit diagram of an AC/AC conversion power supply device for distributing a single-phase or three-phase power supply among homes in a first embodiment of the present invention. The AC/AC conversion power supply device includes a circuit defined by input terminals T1 and T2 and output terminals T3 and T4. An AC power supply of a high voltage (e.g., 6600 V) is connected to the input terminals T1 and T2. Although the AC power supply generally has three phases, a circuit corresponding to only one of the three phases is extracted in the present embodiment.

n (n is an integer; n≧2) rectification circuits D1 to Dn are connected in series with the input terminals T1 and T2 via a fuse F. A voltage of the AC power supply is equally divided into n voltages by the rectification circuits D1 to Dn, and the voltages obtained by the division are respectively converted into DC voltages (pulsating currents) by the n rectification circuits D1 to Dn.

The DC voltages after the conversion are respectively input to n high-frequency switching circuits SC1 to SCn. More specifically, the DC voltage of the first rectification circuit D1 is input to the first high-frequency switching circuit SC1, the DC voltage of the i-th (i is a representative number, which takes any one of 1 to n) rectification circuit Di is input to the i-th high-frequency switching circuit SCi, and the DC voltage of the n-th rectification circuit Dn is input to the n-th high-frequency switching circuit SCn.

Outputs of the high-frequency switching circuits SC1 to SCn are respectively connected to transformers TR1 to TRn, and lowered to predetermined voltage values (e.g., 100 V) by the transformers TR1 to TRn. Output-side rectification circuits D1′ to Dn′ respectively convert voltages obtained by the voltage drop in the transformers TR1 to TRn into DC voltages (pulsating currents). The DC voltages (pulsating currents) have the same magnitude, and are connected in parallel by connection. A voltage obtained by the parallel connection is converted into an AC voltage Vout by an output switching circuit SW for converting the pulsating current on the output side into an AC voltage after an output-side capacitor CL removes a component of a high-frequency switching signal. In such a way, AC/AC conversion is realized.

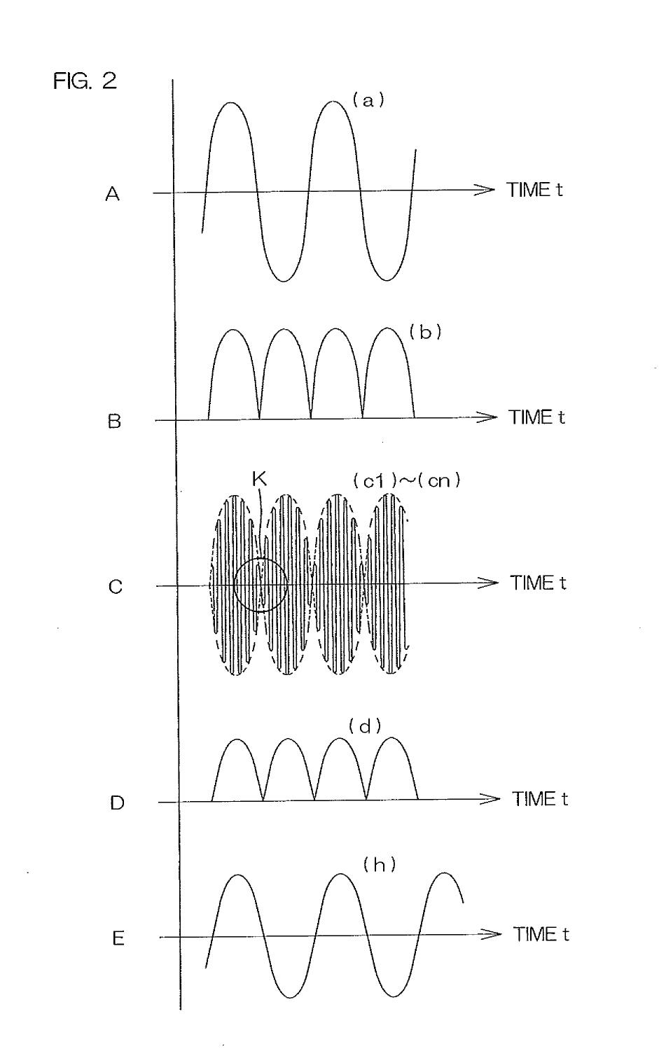

FIG. 2 is a graph illustrating a voltage waveform in each unit in the AC/AC conversion power supply device. FIG. 2A illustrates a waveform (a) of an input voltage Vin of the AC power supply across the input terminals T1 and T2. FIG. 2B illustrates a waveform (b) of a pulsating current obtained by the conversion in each of the rectification circuits D1 to Dn. The waveform (b) is an input voltage to each of the high-frequency switching circuits SC1 to SCn. FIG. 2C illustrates waveforms (c1) to (cn) of AC voltages, which are switched by the high-frequency switching signals, to be output voltages Vout of the high-frequency switching circuits SC1 to SCn. Although the waveforms (c1) to (cn) are not seen, respective phases of the high-frequency switching signals differ from one another. FIG. 20 illustrates a waveform (d) of a pulsating current obtained by rectification in each of the output-side rectification circuits D1′ to Dn′. FIG. 2E illustrates a waveform (h) of an AC voltage obtained by conversion in the output switching circuit SW.

A circuit configuration of the high-frequency switching circuits SC1 to SCn will be described.

Although a high-frequency switching circuit used for the AC/AC conversion power supply device includes the n high-frequency switching circuits SC1 to SCn, the n high-frequency switching circuits SC1 to SCn respectively have their switching phases (switching times) linked together. More specifically, the first high-frequency switching circuit SC1 transmits the phase information to the second high-frequency switching circuit SC2. The second high-frequency switching circuit SC2 transmits the phase information to the third high-frequency switching circuit SC3. In such a way, the phase information reaches the n-th high-frequency switching circuit SCn.

When the function of transmitting the phase information is paid attention to, therefore, the high-frequency switching circuits SC1 to SCn include three types of circuit configurations, i.e., the high-frequency switching circuit SC1 that transmits the phase information, the i-th (i=2 to n−1) high-frequency switching circuit SCi that receives the phase information while transmitting the phase information, and the n-th high-frequency switching circuit SCn that receives the phase information.

The circuit configuration of the first high-frequency switching circuit SC1 will be first described below. The circuit configurations of the i (i=2˜n−1) high-frequency switching circuit SCi and the n-th high-frequency switching circuit SCn will be described later.

The input voltage (the waveform illustrated in FIG. 2B) of the high-frequency switching circuit SC1 is applied to the input side of the first high-frequency switching circuit SC1. A capacitor C11 for absorbing high-frequency noise is connected in parallel with the input side of the first high-frequency switching circuit SC1. A protection circuit PR is provided in parallel with the capacitor C11.

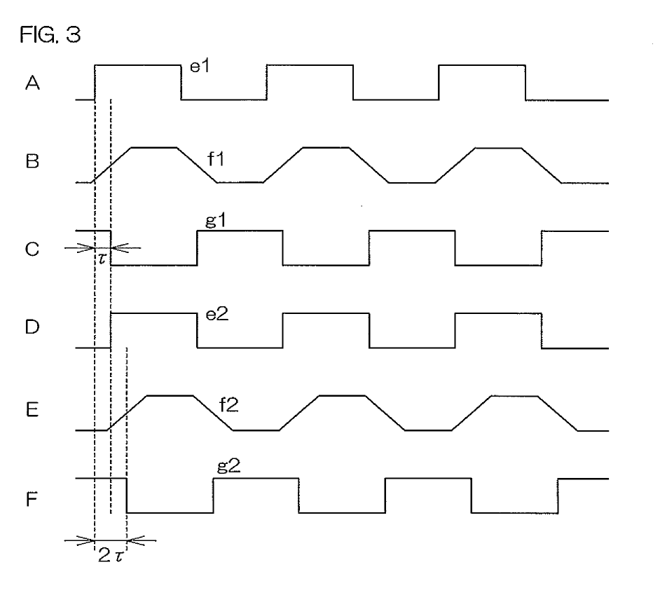

The input voltage to the high-frequency switching circuit SC1 is connected to a high-frequency switching unit including a switching transistor Q13 and a switching transistor Q14. The input voltage is switched on/off at a high frequency (e.g., several ten kilohertz). There is provided an oscillation circuit including inverters S12 and S13, resistors R12 and R13, and a capacitor C12 for generating a switching signal. A switching signal e1 generated by the oscillation circuit is a rectangular pulse signal having a predetermined frequency (see FIG. 3A). The switching signal e1 is applied to the gates of transistors Q11 and Q12 for driving the switching transistors Q13 and Q14. As a result, the output voltage of the first high-frequency switching circuit SC1 is switched at a high frequency (see FIG. 2C).

The switching signal e1 is applied to a CR time constant circuit including a capacitor C14 and a resistor R14, and a signal f1 delayed by a predetermined time τ is output from the CR time constant circuit (see FIG. 3B). The delay time τ is determined by a time constant CR. An inverter S11 waveform-shapes the delayed output signal f1. The waveform-shaped delayed signal is indicated by “g1” in FIG. 3C. The delayed signal g1 is delayed by the time τ from the switching signal e1 generated by the first high-frequency switching circuit SC1.

The delay signal g1 is emitted from a light emission portion of a photo coupler CP1, and is received by a light receiving portion of a photo coupler CP2 in the second high-frequency switching circuit SC2.

The second high-frequency switching circuit SC2 reproduces the delay signal g1 based on a light signal received by the receiving portion of the photo coupler CP2. A switching signal obtained by the reproduction is rectified by an inverter S23, to be a gate signal e2 of a high-frequency switching portion in the second high-frequency switching circuit SC2 (see FIG. 3D). In response to the signal e2, the input voltage of the second high-frequency switching circuit SC2 is switched. However, the switching phase of the switched input voltage is delayed by a time τ from the switching phase of the switched input voltage of the first high-frequency switching circuit SC1.

The switching signal generated in the second high-frequency switching circuit SC2 is applied to a CR time-constant circuit including a capacitor C24 and a resistor R24, and a signal further delayed by a predetermined time τ is output from the CR time constant circuit. The delayed signal is referred to as a “delayed output signal f2” (see FIG. 3E). The delayed output signal f2 is waveform-shaped by an inverter S21. The waveform-shaped delayed signal is indicated by “g2” in FIG. 3F. The delayed signal g2 is delayed by a time 2τ from the signal e1 generated in the first high-frequency switching circuit SC1.

The delayed signal g2 is emitted from alight emission portion of the photo coupler CP2, and is received by a light receiving portion of a photo coupler in the third high-frequency switching circuit SC3.

Similarly, a delayed signal gi emitted from a light emission portion of a photo coupler CPi in the i-th high-frequency switching circuit SCi is received by a light receiving portion of a photo coupler in the (i+1)-th high-frequency switching circuit SCi+1.

In such a way, as the number of each of the high-frequency switching circuits SC1 to SCn is counted down by one, the delay time τ is added. A signal based on the added delay time is generated. In response to this signal, as the number of each of the high-frequency switching circuits SC1 to SCn is counted down by one, the switching phase of the switched input voltage of the high-frequency switching circuit is delayed by τ.

The last n-th high-frequency switching circuit SCn does not require the function of emitting light by the photo coupler, so that the light emitting function is not illustrated in FIG. 1. However, it may have the light emitting function. Similarly, the first high-frequency switching circuit SC1 does not require the function of receiving light by the photo coupler, so that the light receiving function is not illustrated in FIG. 1. However, it may have the light receiving function. A function that is not used may be turned off.

Switching phases of the output voltages of the high-frequency switching circuits SC1 to SCn are thus delayed by a time τ. The value τ is set so that each of the switching phases can be dispersed over one period of a high frequency. More specifically, the delay time τ per one of the high-frequency switching circuits may be set to T/n, where T is one period of a high-frequency switching signal. More specifically, each of the high-frequency switching signals can be equally dispersed over the one period T of the high-frequency switching signal.

The switched output voltages of the high-frequency switching circuits SC1 to SCn are respectively rectified by the output-side rectification circuits D1′ to Dn′, and are connected in parallel by connection. At this time, the output-side capacitor CL smoothes the high frequency so that only a low-frequency component (a frequency of an AC power supply) remains. The output switching circuit SW converts a voltage obtained by the parallel connection into the AC voltage Vout.

As an example of numerical values, a frequency of the AC power supply is 60 Hz (its period is 16.7 milliseconds). The number n of the high-frequency switching circuits SC1 to SCn is four. A frequency of the switching signal is 60 kHz (its period is 0.0167 milliseconds). One period of the switching signal divided by four is a delay time τ per one of the high-frequency switching circuits SC1 to SCn. τ=4.175×10⁻³ milliseconds. The setting of the numerical values enables one period of an AC voltage having a frequency of 60 kHz to be switched at a phase that is delayed every 90°.

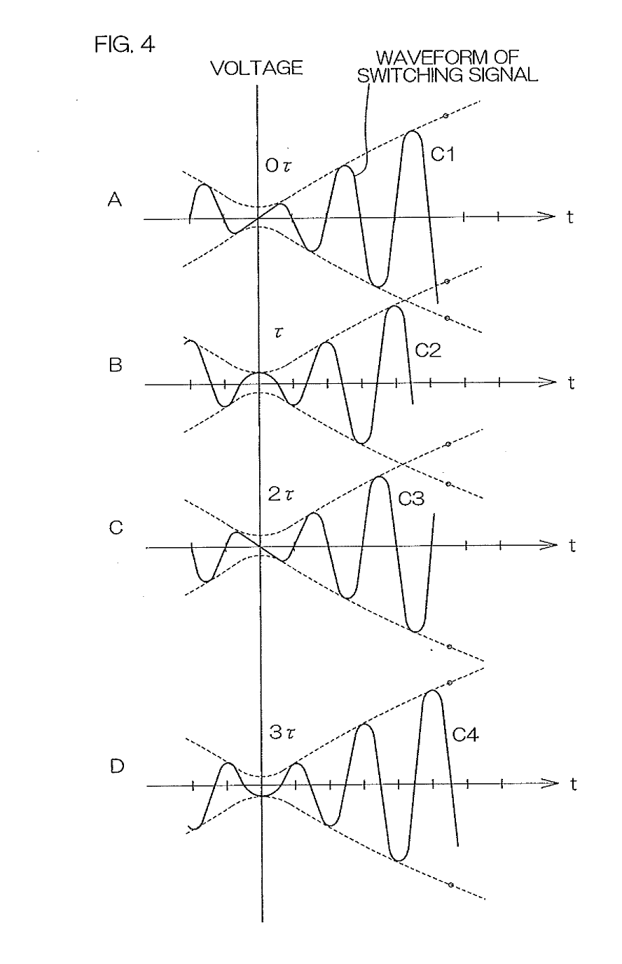

FIG. 4 is an enlarged view illustrating, when the number n of high-frequency switching circuits SC1 to SCn is four, output waveforms of the first to fourth high-frequency switching circuits SC1 to SC4. The enlarged view illustrates a portion K where the AC voltages illustrated in FIG. 2C zero-cross each other.

FIG. 4A is an enlarged view illustrating the output waveform c1 of the first high-frequency switching circuit SC1, and the delay time τ is zero. FIG. 4B is an enlarged view illustrating the output waveform c2 of the second high-frequency switching circuit SC2, and the delay time is τ (corresponding to 90°). FIG. 4C is an enlarged view illustrating the output waveform c3 of the third high-frequency switching circuit SC3, and the delay time is 2τ (corresponding to 180°). FIG. 4D is an enlarged view illustrating the output waveform c4 of the fourth high-frequency switching circuit SC4, and the delay time is 3τ (corresponding to 270°).

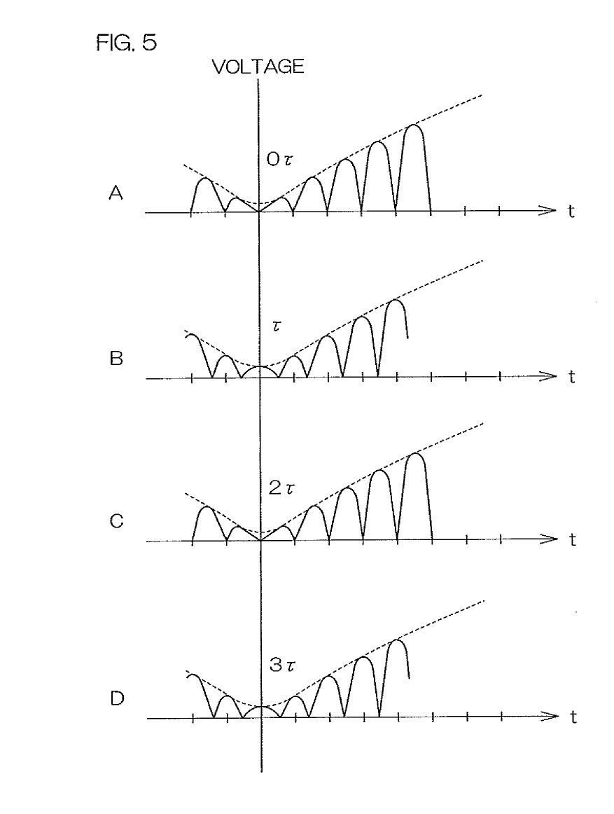

FIG. 5 illustrates waveforms obtained by rectifying and pulsating the above-mentioned four waveforms, respectively, by the output-side rectification circuits D1′ to Dn′. FIG. 5A corresponds to a waveform obtained by pulsating the waveform C1 illustrated in FIG. 4A, FIG. 5B corresponds to a waveform obtained by pulsating the waveform C2 illustrated in FIG. 4B, FIG. 5C corresponds to a waveform obtained by pulsating the waveform C3 illustrated in FIG. 4C, and FIG. 5D corresponds to a waveform obtained by pulsating the waveform C4 illustrated in FIG. 4D. Each of the waveforms is drawn for illustration. The waveforms are added together by connection. Therefore, the waveforms cannot be actually observed.

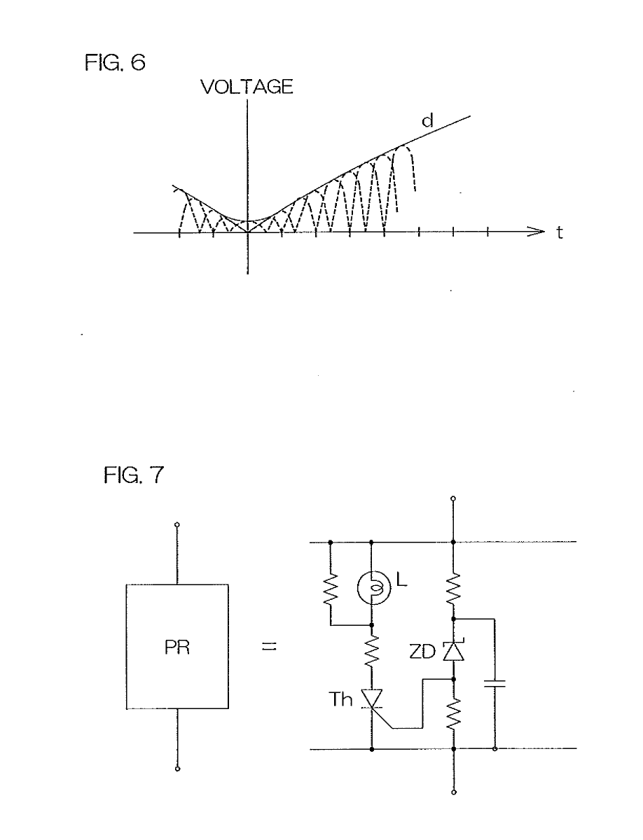

FIG. 6 illustrates a waveform obtained by adding the signal waveforms illustrated in FIG. 5. In FIG. 6, each of switching waveforms is drawn by a broken line, and a waveform obtained by smoothing the switching waveform by the output-side capacitor CL is drawn by a solid line.

As can be seen from FIG. 6, the waveforms of high-frequency switching signals included in the output waveforms of the high-frequency switching circuits SC1 to SCn respectively have their phases dispersed over one period of the high frequency. Therefore, the switching waveform is effectively smoothed when smoothed by the output-side capacitor CL because a low-frequency component of its spectrum is reduced. Accordingly, high-frequency components included in the output waveforms of the high-frequency switching circuits SC1 to SCn are reduced. As a result, noise included in the AC voltage Vout obtained by the conversion in the output switching circuit SW is also reduced. The capacity (rectifying ability) of the output-side capacitor CL can be made low, and a rush current can be dispersed. Accordingly, high efficiency of the AC/AC conversion power supply device can be implemented.

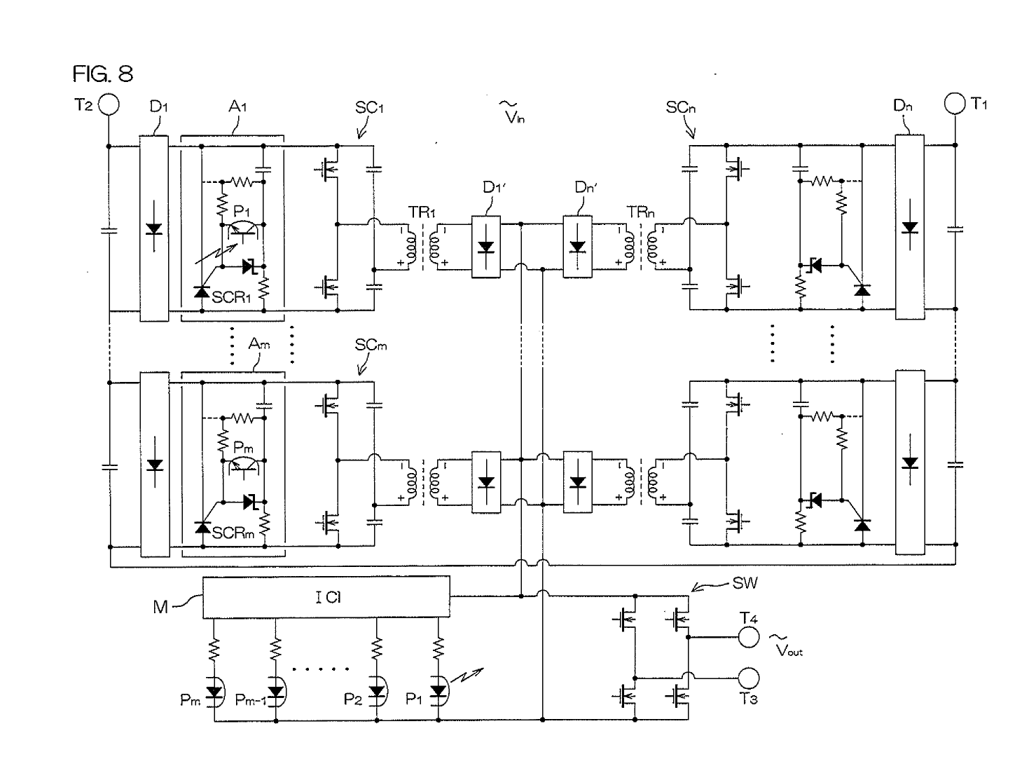

FIG. 7 is a circuit diagram of the protection circuit PR included in each of the high-frequency switching circuits SC1 to SCn. The protection circuit PR makes notification using a lamp L that an input voltage of the corresponding high-frequency switching circuit has risen. When any one of the high-frequency switching circuits SC1 to SCn is short-circuited on its input side, input voltages of the remaining normal high-frequency switching circuits SC1 to SCn rise. Therefore, voltages on the output side of the high-frequency switching circuits SC1 to SCn also rise, to adversely affect a load device.

The protection circuit PR includes a Zener diode ZD and a thyristor Th. The Zener diode ZD detects an input voltage of each of the high-frequency switching circuits SC1 to SCn. If the input voltage exceeds a predetermined reference voltage, the Zener diode ZD breaks down, so that the thyristor Th is rendered conducted by being triggered. This enables the lamp L to light up, enabling notification of a voltage rise to the exterior. The reference voltage can be set by selecting the Zener diode ZD having a breakdown voltage. The notification may be made by any means such as display of a warning screen on a display and sending a warning signal to the exterior in addition to the lighting of the lamp L.

FIG. 8 is a circuit diagram of an AC/AC conversion power supply device including the function of adjusting an output voltage Vout. The AC/AC conversion power supply device includes a monitoring control circuit M for monitoring the output voltage Vout.

The monitoring control circuit M includes photo couplers P1 to Pm the number m of which is lower than the number n of high-frequency switching circuits SC1 to SCn (m<n), to turn on parts or all of the photo couplers P1 to Pm according to a detection value of the output voltage Vout.

The monitoring control circuit M turns on, out of the photo couplers P1 to Pm, the photo couplers the number of which corresponds to a difference between the output voltage Vout and a predetermined reference voltage.

When the reference voltage is 100 V, for example, a reference number (e.g., the half of m) of photo couplers light up if the output voltage Vout is 100 V that is the same as the reference voltage. If the output voltage Vout exceeds the reference voltage, a predetermined number of photo couplers sequentially go out. If the output voltage Vout falls below the reference voltage, more than a predetermined number of photo couplers sequentially light up.

For example, one photo coupler goes out if the output voltage Vout is higher than the reference voltage by 1 V, and two photo couplers go out if it is higher than the reference voltage by 2 V. Conversely, one photo coupler lights up if the output voltage Vout is lower than the reference voltage by 1 V, and two photo couplers light up if it is lower than the reference voltage by 2 V.

Although the total number of high-frequency switching circuits SC1 to SCn is n, them high-frequency switching circuits respectively include output voltage adjustment circuits A1 to Am. The high-frequency switching circuits SC1 to SCm respectively including the output voltage adjustment circuits A1 to Am are hereinafter represented by a high-frequency switching circuit SCi.

The high-frequency switching circuit SCi includes a photo coupler receiving portion Pm corresponding to the photo coupler Pi in the monitoring control circuit M, and a thyristor SCRi connected in parallel with the high-frequency switching circuit SCi. A trigger voltage of the thyristor SCRi exceeds a threshold when the photo coupler light receiving portion Pm receives light, so that the thyristor SCRi is rendered conductive. Thus, the high-frequency switching circuit SCi is short-circuited.

In summary, if the output voltage Vout falls below the reference voltage, more than a reference number of photo couplers light up. High-frequency switching circuits corresponding to the photo couplers that light up are correspondingly short-circuited. The number of high-frequency switching circuits SC1 to SCn connected in series, as viewed from input terminals T1 and T2, decreases. Therefore, a voltage per one of the high-frequency switching circuits SC1 to SCn rises, and the output voltage Vout of the AC/AC conversion power supply device also rises.

If the output voltage Vout exceeds the reference voltage, some of the photo couplers that light up go out. Thyristors in the high-frequency switching circuits corresponding to the photo couplers that go out are correspondingly opened, and the number of high-frequency switching circuits connected in series, as viewed from the input terminals T1 and T2, increases. Therefore, a voltage per one of the high-frequency switching circuits falls, and the output voltage Vout of the AC/AC conversion power supply device also falls.

This enables the output voltage Vout of the AC/AC conversion power supply device to be made constant. The loss and the cost of the AC/AC conversion power supply can be made lower, as compared with those in another method for stabilizing an output voltage.

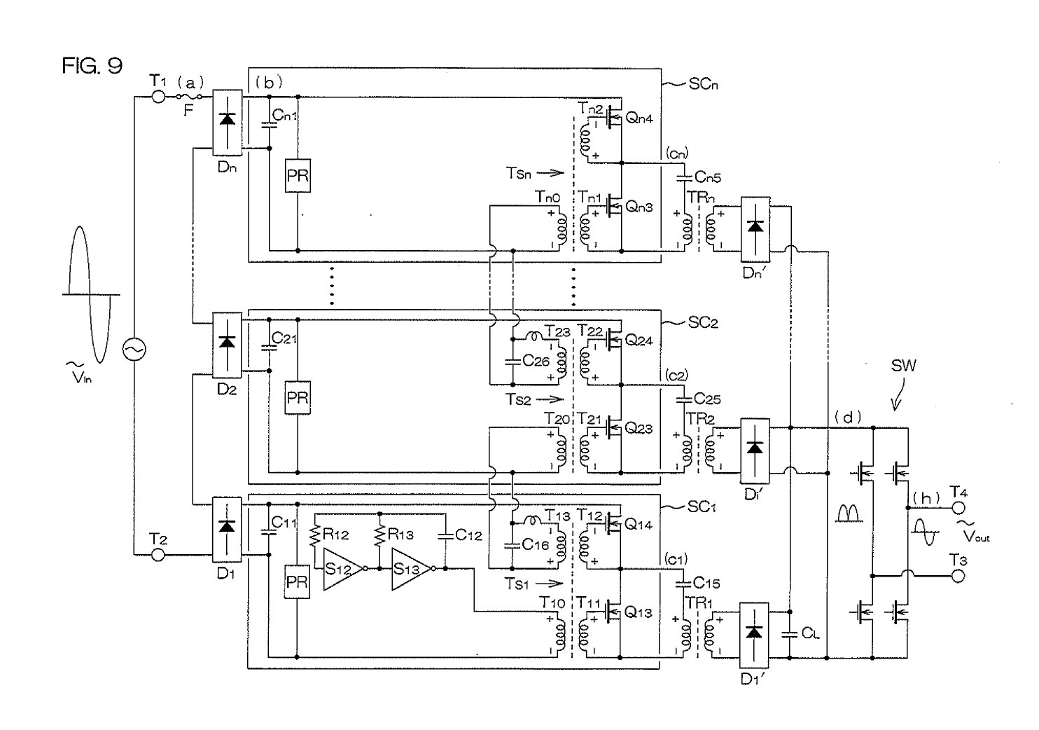

FIG. 9 is a circuit diagram illustrating another delay circuit for delaying the phase of a high-frequency switching signal in a high-frequency switching circuit. In this circuit configuration, a tertiary winding of a pulse transformer Tsi for supplying a gate voltage to switching transistors Qi3 and Qi4 in a high-frequency switching circuit SCi is used, to generate a signal delayed by a time τ.

More specifically, a pulse transformer Ts1 for supplying a gate voltage to switching transistors Q13 and Q14 is provided in a high-frequency switching circuit SC1 in the lowermost stage illustrated in FIG. 9. The pulse transformer Ts1 includes a primary winding T10 for causing a switching signal from an oscillation circuit including inverters S12 and S13, resistors R12 and R13, and a capacitor C12, secondary windings T11 and T12 for generating gate voltages of the switching transistors Q13 and Q14, and a tertiary winding T13 for generating a delay signal. A capacitor C16 is connected in parallel with the tertiary winding T13. A leakage inductance (corresponding to an inductance displayed in series with the tertiary winding T13 in FIG. 9) and a capacitance of the capacitor C16 form a signal delayed by a time τ. The time τ can be selected by adjusting the value of the capacitor C16.

A signal of the tertiary winding T13 is fed to a primary winding T20 of a pulse transformer Ts2 in a high-frequency switching circuit SC2 in the next lower stage. The ternary winding T13, the primary winding T20, and the capacitor C16 constitute a “delay circuit” using a transformer. A signal fed to the primary winding T20 drives secondary windings T21 and T22, to perform a switching operation of switching transistors Q23 and Q24. Simultaneously, a ternary winding T23 is driven, to generate a delay signal further delayed by a time τ. This causes a signal, which is delayed by a time 2τ from the signal generated by the oscillation circuit in the high-frequency switching circuit SC1, to be obtained. The delayed signal is used for a switching operation of the subsequent high-frequency switching circuit SC3.

In a similar way, signals that are delayed by a time τ are generated, and switching operations of the high-frequency switching circuits SC2, SC3, . . . are delayed by the time τ. In order to equally disperse each of switching phases of the high-frequency switching circuits over one period of a high frequency, a delay time τ per one of the high-frequency switching circuits may be set to T/n, where T is one period of a high-frequency switching signal, as described above.

An example of circuit connection in which the AC/AC conversion power supply device having the above-mentioned configuration is applied to a three-phase alternating current will be described below.

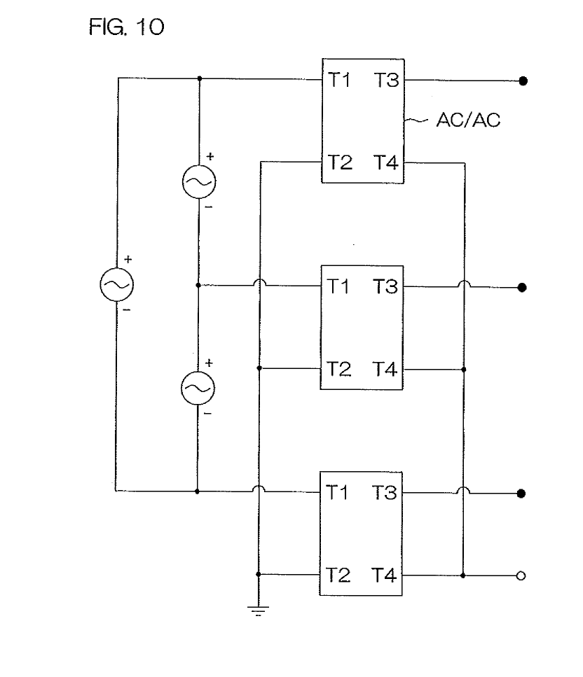

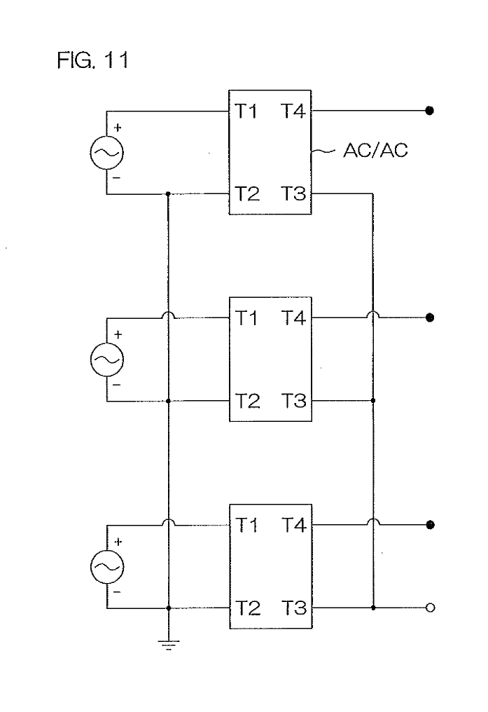

FIG. 10 illustrates an example of connection in which an AC/AC conversion power supply device is Δ (delta)-connected. FIG. 11 illustrates an example of connection in which the AC/AC conversion power supply device is Y-connected. In FIGS. 10 and 11, “o” denotes a neural line. In any case, if three AC/AC conversion power supply devices illustrated in FIG. 1 are prepared, and are interconnected so that a three-phase alternating current can be handled, a three-phase AC output obtained by converting a three-phase AC input can be obtained.

Although the embodiment of the present invention has been described, the present invention is not limited to the above-mentioned embodiment. For example, a transmission circuit for transmitting a waveform of a high-frequency switching signal delayed by a delay circuit from one high-frequency switching circuit to another high-frequency switching circuit is not limited to a photo coupler. It may be a communication line. Various changes can be made within the scope of the present invention.

1. An AC/AC conversion power supply device comprising:
n (n≧2) rectification circuits connected in series with an AC input;
n high-frequency switching circuits respectively connected to outputs of the rectification circuits;
n transformers respectively having primary windings connected to outputs of the high-frequency switching circuits; and
output-side rectification circuits respectively connected to secondary windings of the n transformers,
wherein each of output after rectification of the output-side rectification circuits is connected in parallel with one another, and
further comprising an output switching circuit for converting the output after the rectification of the output-side rectification circuits into an AC voltage.

2. The AC/AC conversion power supply device according to claim 1, wherein at least one of the high-frequency switching circuits includes a delay circuit capable of delaying a waveform of a high-frequency switching signal.

3. The AC/AC conversion power supply device according to claim 2, further comprising a transmission circuit that transmits the waveform of the high-frequency switching signal, which has been delayed by the delay circuit, from one of the high-frequency switching circuits to the other high-frequency switching circuits.

4. The AC/AC conversion power supply device according to claim 1, wherein
each of the high-frequency switching circuits has a second transformer installed therein to cause a transistor device to perform a switching operation,
the second transformer includes a primary winding for receiving of the high-frequency switching signal, a secondary winding connected to the transistor device, and a ternary winding for delaying the waveform of the high-frequency switching signal, and
an output of the ternary winding is connected to a primary winding of a second transformer in the other high-frequency switching circuit.

5. The AC/AC conversion power supply device according to claim 1, further comprising a high-frequency smoothing device connected to the output after the rectification of the output-side rectification circuit for absorbing a high frequency of the high-frequency switching circuit.

6. The AC/AC conversion power supply device according to claim 1, further comprising a protection circuit for notifying a fact that an output voltage of the AC/AC conversion power supply device exceeds a threshold.

7. The AC/AC conversion power supply device according to claim 1, further comprising
a short circuit that can short-circuit the input side of the high-frequency switching circuit, and
a monitoring control circuit that can adjust an output voltage of the AC/AC conversion power supply device by detecting the output voltage of the AC/AC conversion power supply device, comparing the detected voltage with a reference value, and setting the number of high-frequency switching circuits the input side of which is short-circuited according to a difference between the detected voltage and the reference value.
